(19) United States
(12) Patent Application Publication
(10) Pub. No.: US 2003/0187766 A1
(43) Pub. Date: Oct. 2, 2003

(54) Automated risk management system and method

(75) Inventor: Ichiro Akashi, New Milford, NJ (US)

Correspondence Address: OSTROLENK FABER GERB & SOFFEN, 1180 AVENUE OF THE AMERICAS, NEW YORK, NY, 100368403

(73) Assignee: Nissho Iwai American Corporation

(21) Appl. No.: 10/112,915

(22) Filed: Mar. 29, 2002

(51) Int. Cl. G06F 17/60

(52) U.S. Cl. 705/35

(57) ABSTRACT

The present invention relates to a system and method which enables companies to authorize, implement, track and eventually complete short and long term investments. Companies are also enabled to monitor the progress of all investment projects in the company. The invention receives information from one or more parties directed to one or more action plans associated with a project. Users of the system preferably evaluate the action plan information and assign indicators to represent the status of project-related activity. The present invention preferably appraises each project by appraising the action plans associated therewith, and assigning an investment project indicator that is equivalent to the least favorable status indicator among all of the action plans associated with the project. The present invention also compiles all project indicators in an overview screen that allows parties to understand the overall investment project status of the company.

### FIELD OF THE INVENTION

The present invention relates to a system and method for managing exposure associated with such things as investments and loans. More particularly, the invention relates to a system and method which enables companies to authorize, implement, track and eventually complete short and long term investments.

### BACKGROUND OF THE INVENTION

Managing credit exposure for corporations remains a critical component of a successful business. Risk can be incurred in a plurality of ways. For example, investment transactions, long and/or deferred payment transactions, and real estate loan transactions incur risk that must be managed in order for an investment transaction to be profitable. Risk is also incurred from non-capital investments, including investments in inventory, machinery and supplies.

Over time, computer software applications have been developed to assist with managing projects related to investments. Automated systems have been developed that enable management to automatically receive information regarding investment projects. For example, prior art automated systems enable project members to electronically submit information regarding the investments with which they are associated. The development of such automated systems has greatly improved communications between project and task members. However, prior art management tools only focus on managing existing exposure, not preventing it.

While recent developments in automated project management systems have resulted in tools that enable parties to manage project tasks and dates, prior art project management tools do not completely integrate a company's entire risk portfolio. For example, in prior art project management systems, managers assign tasks to project members, who, as information directed to the members' contributions is received, update the system. If a problem does arise, the assigned project member typically, out of fear of getting into trouble, makes positive reports on the project's status. He/she rationalizes his/her report by hoping that the problem will be resolved shortly. Even when the problem extends beyond what was first anticipated, he/she continues to make positive reports that the project is going well. Moved by fear of being castigated and relying on the glimmer of hope that the problem will be resolved soon, the person continues to keep the problem a secret. As the situation continues to worsen and gets out of control, management eventually finds out. However, by that time there is not much that anyone can do to resolve the situation. Ultimately, the corporate decision-making process is delayed because, driven by his/her expectations and fears, the assigned project member failed to report accurate information. However, if problems were to be discovered at their initial stages, not only could the problems be resolved quickly and easily, but also the project member would not suffer unnecessary anxiety and stress.

In addition, typically, management informs upper management and executives of the progress of the respective projects that are being implemented. Upper management and corporate executives typically use the information they receive from management to develop future investment strategies. For example, after reviewing information received from a project manager, executive committee members may decide to increase resources for similar projects in the future, or, alternatively, may decide not to invest in similar projects. However, upper management must wait for management to report to them. Also, especially with long-term projects, upper management might not be notified of certain issues because a manager might have quit the company and did not leave any information with the next manager. In another instance, a manager might simply decide to withhold certain information from upper management.

### SUMMARY OF THE INVENTION

Investments that are implemented by departments within corporations frequently have risk associated therewith. Managing risk associated with investments is necessary in order to realize profit. On the corporate level, an invention is needed that allows top decision makers to get a view of projects in the company quickly, at the click of a button. By providing an overview display, the present invention eliminates time wasted in waiting for management to report and eliminates the possibility of management withholding information.

Also, on an individual project level, an invention is needed that tracks required tasks, or actions, that are involved with each investment project before exposure arises. By using a system of checks and follow-ups, the present invention prevents exposure and greatly reduces the possibility of projects unnecessarily incurring risk. Actions that are associated with projects are registered, and due to meticulous follow-ups during the life cycle of any given project, the invention knows in advance required tasks, or actions, associated with investment projects.

The present invention enables a plurality of parties associated with an investment project to transmit and receive information over a global communication network in order to maintain current information directed to the status of investments and other associated activities. The present invention preferably compiles information received from project members into useful and informative formats.

The present invention receives information from one or more parties directed to one or more actions associated with an investment. Users of the system, for example, investment committee representatives preferably evaluate action information received by the present invention, and, thereafter, assign indicators to represent the status of investment-related activity. The present invention preferably assesses each investment project by appraising all of the actions associated therewith, and by assigning an project indicator that is equivalent to the least favorable status indicator among all of the actions associated with the investment. For example, an investment project comprising five actions, four of which are appraised as exemplary and one of which is appraised as critical, would be appraised as critical.

The present invention preferably receives forecast information from one or more parties that represent factors that potentially mitigate the successful outcome of an investment project. For example, a particularly harsh winter could potentially mitigate a return on an investment in orange juice futures.

The present invention further receives information directed to parties who are associated with an investment. For example, the present invention receives project member information, project leader information, and the like. In a preferred embodiment, the present invention preferably receives information directed to tasks associated with project members. A schedule for associated activities is further received by the present invention.

The present invention preferably notifies parties who are associated with an investment project when at least one activity is not performed in accordance with a time schedule. As time passes and activity remains delinquent, the number of people in positions of higher responsibility that are notified by the present invention preferably increases. Moreover, the severity of the message content likewise preferably increases.

### BRIEF DESCRIPTION OF THE DRAWING(S)

For the purposes of illustrating the invention, there is shown in the drawings a form which is presently preferred, it being understood however, that the invention is not limited to the precise arrangements and instrumentalities shown. The features and advantages of the present invention will become apparent from the following description of the invention that refers to the accompanying drawings, in which:

FIG. 1 illustrates a hardware arrangement for a preferred embodiment of the present invention;

FIG. 2 is a block diagram of the functional elements constructed in accordance with the present invention;

FIG. 3 shows a block diagram identifying the preferred modules constructed in accordance with the principles of the present invention;

FIG. 4A is a flow chart identifying the processes associated with logging into the present invention;

FIG. 4B is a flow chart showing the high level processes in accordance with the principles of the present invention;

FIG. 5 shows a flow chart identifying the details associated with submitting investment details in accordance with the principles of the present invention;

FIG. 6 depicts a flow chart identifying the processes associated with developing and monitoring actions associated with an investment in accordance with the principles of the present invention;

FIG. 7 shows an example new project display screen that is used for adding new proposal information in the present invention;

FIG. 8 displays a sample add a new project form that is used when a user formally adds a new project in automated risk management system 10;

FIG. 9 depicts an add a new member display screen for adding new members to a project;

FIG. 9A shows an example add a new partner display screen that is used for adding partners in the project;

FIG. 10 illustrates a project member list display screen that shows members associated with a project;

FIG. 11 illustrates an add a new action plan display screen that is used for adding actions to a specific project;

FIG. 12 illustrates a review action plan display screen that shows details directed to an action plan associated with a project;

FIG. 13 depicts an action plan list display screen that shows all action plans associated with a specific project;

FIG. 14 is a sample warning notification transmitted to members in response to a delinquent action plan;

FIG. 15 is a sample notification that an action plan has been updated and requires a status change;

FIG. 16 illustrates the information module in accordance with the principles of the present invention;

FIG. 17 depicts the project forum in accordance with the principles of the present invention;

FIG. 18 shows the project forecast module in accordance with the principles of the present invention;

FIG. 19 depicts an action plan update by committee display screen used for assigning an action plan status indicator to a specific action plan;

FIG. 19A is a sample action plan history display screen that shows a history of updates and changes that occurred during an action plan;

FIG. 20 illustrates an investment project overview display screen that identifies investment projects associated with departments and the status indicators associated with the projects;

FIG. 21 is another sample project overview display screen that identifies a change of status for an investment project; and

FIG. 22 is a sample reports display screen used to access various reports in accordance with the principles of the present invention.

### DETAILED DESCRIPTION OF THE PREFERRED EMBODIMENTS

The present invention comprises a plurality of data input and output modules that are preferably available via a global communication network, for example, the Internet. The modules receive information in a plurality of formats, process the information into at least one meaningful application, and transmit information to one or more parties. The integrated system of modules provides users with continuous and current assessments of investments having some form of risk.

As used herein, the term “project” refers to any investment that can be implemented. Examples of projects include capital investments, payment transactions, loans, acquisitions, inventory, machinery and supplies purchases.

Also as used herein, the term “action plan” refers to activity associated with a project that serves to implement the project. Action plans are associated with projects and are carried out during the course of a project.

As used herein, the terms “action member” refer to a person who is responsible for implementing an action plan. Action members are typically staff personnel who are assigned duties related to action plans. Action members may include partners, as defined below.

As used herein, the term “partner” refers to a person who is not directly affiliated with a company implementing a project, for example is not an employee of the company, and yet has at least one responsibility associated with a project. Partners can have direct responsibilities associated with action plans, and, alternatively, can have responsibilities associated with a project.

Also as used herein, the term “project leader” refers to a person who is responsible for a project. Project leaders are responsible for ensuring that project members are completing the action plans associated with projects in a timely and effective manner.

Further as used herein, the term “project member” refers to a person who has responsibilities associated with a project. Project members include action members, partners and project leaders.

As used herein, the term “user” refers to a person or group of people who use the present invention to submit and/or receive information directed to one or more projects.

Also as used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

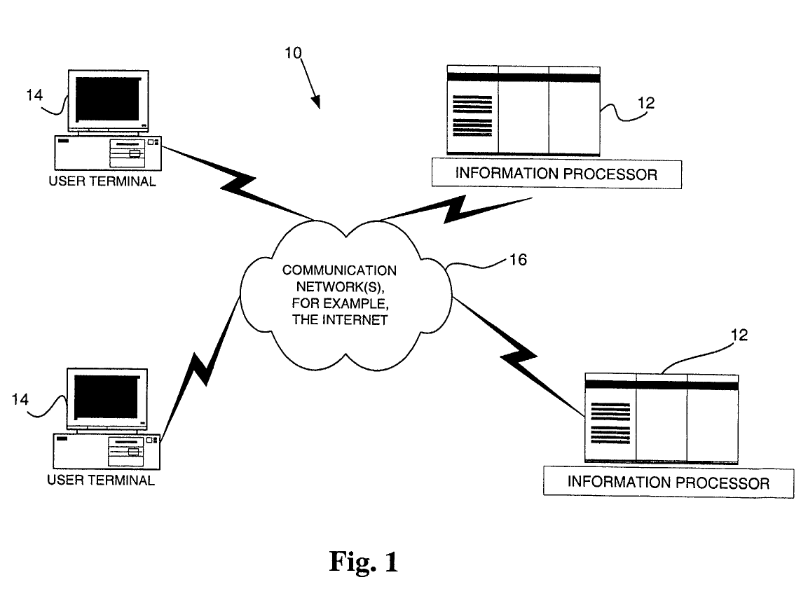

Referring to the drawing figures in which like reference designators refer to like elements, there is shown in FIG. 1, an example of a hardware arrangement for a networked based system for managing risk, constructed in accordance with the principles of the present invention and designated generally as the “automated risk management system 10.” The automated risk management system 10 is comprised of at least one information processor 12 and at least one user terminal 14, each of which communicate via communication network 16. Information processor 12 preferably includes all databases necessary to support the present invention. However, it is contemplated that information processor 12 can access any required databases via communication network 16 or any other communication network to which information processor 12 may be coupled. Communication network 16 is preferably a global public communication network such as the Internet, but can also be a wide area network (WAN), local area network (LAN), or even a single computer.

In a preferred embodiment, information processor 12 and user terminal 14 are any devices that are capable of sending and receiving data across communication network 16, i.e., mainframe computers, mini computers, personal computers, laptop computers, personal digital assistants (PDA) or Internet access devices such as Web TV. In addition, user terminals 14 are preferably equipped with a web browser, such as MICROSOFT INTERNET EXPLORER, NETSCAPE NAVIGATOR and the like. Information processors 12 and terminals 14 are preferably coupled to communication network 16 using any known data communication networking technology.

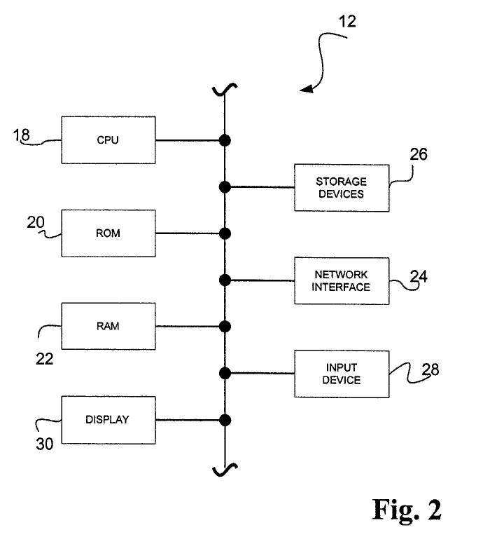

As shown in FIGS. 1 and 2, the functional elements of each information processor 12 include one or more central processing units (CPU) 18 used to execute software code and control the operation of information processor 12, read-only memory (ROM) 20, random access memory (RAM) 22, one or more network interfaces 24 to transmit and receive data to and from other computing devices across a communication network, storage devices 26 such as a hard disk drive, floppy disk drive, tape drive, CD ROM or DVD or storing program code, databases and application data, one or more input devices 28 such as a keyboard, mouse, track ball, microphone and the like, and a display 30.

The various components of information processor 12 need not be physically contained within the same chassis or even located in a single location. For example, storage device 26 may be located at a site which is remote from the remaining elements of information processors 12, and may even be connected to CPU 18 across communication network 16 via network interface 24. Information processors 12 include a database equipped with sufficient storage to provide the necessary databases, forums, and other community services as well as acting as a web server for communicating hypertext markup language (HTML), Java applets, Active-X control programs and the like to user terminals 14. Information processors 12 are arranged with components, for example those shown in FIG. 2, suitable for the expected operating environment of information processor 12. The central processing unit(s) 18, network interface(s) 24 and memory 20, 22 and storage devices 26 are selected to ensure that capacities are arranged to accommodate expected demand.

The functional elements shown in FIG. 2 (designated by reference numerals 18-30) are of the same categories of functional elements present in user terminals 14. However, not all elements need be present, for example, storage devices in the case of PDA's and the capacities of the various elements are arranged to accommodate the expected user demand. For example, CPU 18 in user terminal 14 may be a smaller capacity CPU than the CPU present in the information processor 12. Similarly, it is likely that the information processor 12 will include storage devices of a much higher capacity than storage devices present in user terminal 14.

Of course, one of ordinary skill in the art will understand that the capabilities of the functional elements can be adjusted as needed. The nature of the invention is such that one skilled in the art of writing computer executable code (software) can implement the described functions using one or more or a combination of a popular computer programming languages including, but not limited to C++, Visual Basic, Java, Active-X, HTML and web application development environments.

Although the present invention is described by way of example herein and in terms of a web-based system using web browsers and a web site server (information processor 12), system 10 is not limited to the above configuration.

It is contemplated that the automated risk management system 10 can be arranged such that user terminals 14 can communicate with and display data received from information processors 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on user terminal 14, for example, OS/400, VMS, AIX, MVS, MS-DOS, Windows 3.x, Windows 95, Windows 98, Windows NT, Windows 2000, Windows XP, Windows ME, Windows CE, Mac OS, Unix, Linux, Palm OS and any suitable PDA operating system.

Further, as used herein, references to displaying data on user terminal 14 refer to the process of communicating data to the terminal across communication network 16 and processing the data such that the data can be viewed on the user terminals' display 30 using a web browser or the like. The display screen on user terminals 14 present areas within the automated risk management system 10 such that a user can proceed from area to area by selecting a desired link. Therefore, each user's experience with the automated risk management system 10 will be based on the order with which he/she progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of the automated risk management system 10.

The above-described hardware arrangement provides a system that advantageously allows users to manage projects having risk. The specific functionality provided by the automated risk management system 10, and in particular information processors 12, is described in detail below.

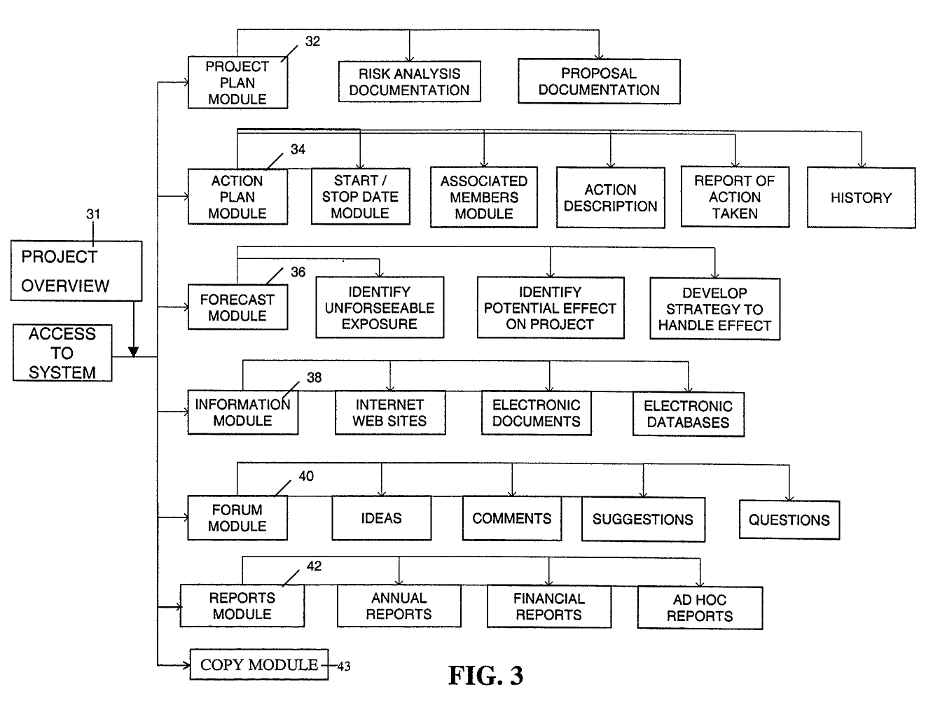

The functionality associated with the automated risk management system 10, including the interaction between the modules, is now described with reference to block diagrams and flow charts shown in FIG. 3 through FIG. 6.

Referring now to FIG. 3, the functionality provided by the present invention is preferably available via a plurality of input/output modules. In a preferred embodiment, the modules include a project overview module 31, a project plan module 32, an action plan module 34, a forecasting module 36, an information module 38, a forum module 40, a reports module 42, and a copy module 43. This list of choices is not exhaustive, of course, one skilled in the art will recognize that additional input/output modules, for example electronic file management and output, can be added. A detailed discussion regarding the input/output modules and their associated functionality is provided below.

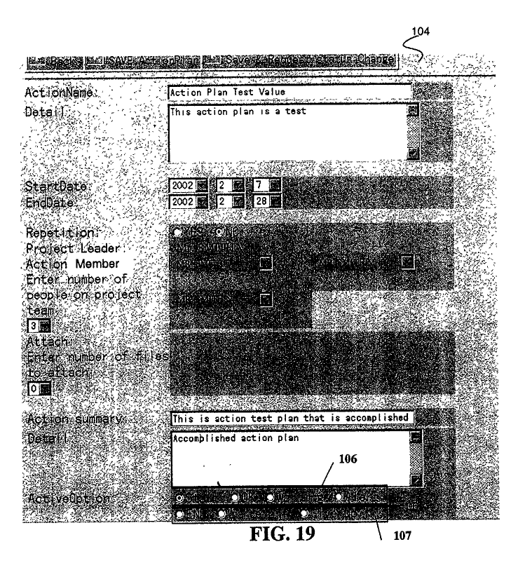

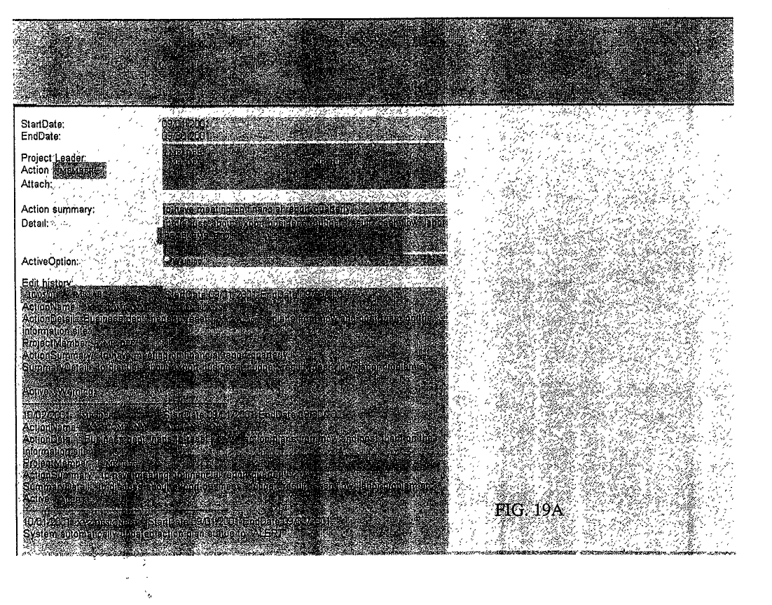

The project plan module 32 enables users to add new project plans and review existing ones. Users preferably transmit information directed to the project, for example, risk analysis documentation and investment proposal documentation, prior to a new project being added to the automated risk management system 10. After selecting the action plan module 34, a user preferably submits a plurality of information, including starting and ending dates for an action plan, the members who are associated with the action plan, textual descriptions of the action plan, and electronic documents (attachments). Eventually, the information is compiled into a history of action plans associated with a specific project. A discussion regarding maintaining a history of action plans is provided below, with reference to FIG. 19A. The forecast module 36 is available for a user to submit potentially unforeseeable risk exposure, for example, terrorist activity, and the potential effect that the risk exposure has on the project. The forecast module 36 includes prompts for users to identify potential effects on a project, and further to submit strategies for handling the exposure.

The information module 38 affords users access to a plurality of information sources, for example Internet web sites, electronic documents, electronic databases, and host system data. When a user accesses the forum module 40, the user is provided with a newsgroup-style environment wherein ideas, suggestions and questions are preferably submitted. He or she accesses the reports module 42 for a plurality of information reports, for example, financial reports, project member reports and a plurality of ad hoc reports made available through a plurality of information sources, for example Internet web sites, electronic documents and electronic databases. The copy module 43 affords users access to a plurality of templates. For example, when a new project is added to the automated risk management system 10, a template created from a similar previously implemented project found in the copy module 43 is preferably used as a model to implement the new project. The modules described herein preferably form a logical, systematic and integrated system for managing risk.

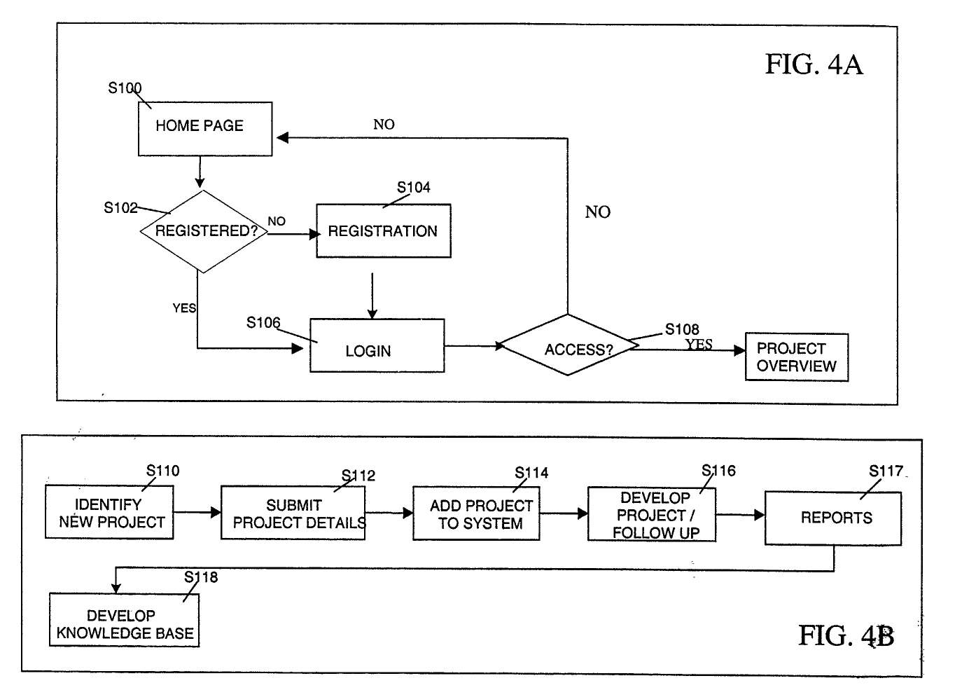

FIG. 4A illustrates high level functionality of automated risk management system 10 and represents procedural steps associated with accessing restricted areas of the automated risk management system 10 included in a preferred embodiment of the present invention. In a preferred embodiment, a user operating user terminal 14 enters the automated risk management system 10 by visiting a home page web site (step S100). In order to gain access to restricted areas of the automated risk management system 10, the user must register and obtain a unique user identification name and a password. In step S102, the system preferably evaluates whether the user is registered. If the user is not already registered, then he or she must be registered by an authorized person (step S104). In a preferred embodiment of the present invention, the person registering with the automated risk management system 10 will initially be provided with a registration name (e.g., the participant's social security number) and a password (preferably randomly generated by the system). Thereafter, the user accesses the automated risk management system 10 using his or her identification name and the password. As noted above concerning user authorization, the automated risk management system 10 preferably recognizes a user's authorization level, and, in response thereto, grants or restricts access to specific areas. Of course, one skilled in the art will recognize that authorization can be granted and removed over time. Moreover, the security features of the present invention that restrict access to the automated risk management system 10 can be implemented in a plurality of ways. For example, a plurality of encryption methods known in the art, including digital signature and secured sockets layer, are contemplated herein.

In a preferred embodiment, once a user registers, for example, by submitting an electronic registration data entry form and receiving authorization clearance, he or she thereafter provides his or her unique user identification and password in order to “log in” and access restricted areas of the automated risk management system 10 (step S106). Once a user submits his or her identification name and password, the information processor 12 makes a determination whether to authenticate the user and grant access to restricted areas of the automated risk management system 10 (step S108). If the information processor 12 concludes that the person completing the form is not authorized to access restricted areas of the automated risk management system 10, entry is denied and the user is presented with the “home” page, described in step S100.

FIG. 4B shows high level processes associated with a preferred embodiment of the automated risk management system 10. In step S110, a department proposes a new project, for example, a real estate transaction. Thereafter, documentation directed to the project is submitted to an investment committee for approval (step S112). After the investment committee convenes and approves the project, the project is added to the automated risk management system 10. (step S114).

In step S116, the newly added project in the automated risk management system 10 is closely monitored until its eventual completion. During and after implementing a project, a plurality of information reports is preferably made available in step S117. The reports comprise, for example, pre-designed and ad hoc financial reports, personnel reports and details of the project. Throughout the entire process, all information that is received and compiled during the projects development is stored in an accessible knowledge base for future reference (step S118).

The knowledge base preferably includes a search tool that assists users to manage current projects as well as future projects. In a preferred embodiment, the search tool comprises a text-box control that a user of the automated risk management system 10 enters text in. The text preferably represents the criteria the user desires for the search. After the text is entered, the user preferably clicks a graphic control, such as a button, and the automated risk management system 10 searches the knowledge base through, for example, projects, action plans, and information submitted in modules associated with the automated risk management system 10, including forecasts, forums, reports, electronic documents, spreadsheets, presentations and the like for occurrences of the text submitted by the user. The results of the search, including projects and action plans, are preferably listed and formatted as hyperlinks. When the user selects a hyperlink corresponding with a desired project and/or action plan, details directed thereto are further displayed. Preferably, the automated risk management system 10 highlights the occurrence in the selected project or action plan where the search text, as originally submitted by the user, appears.

The search tool is very helpful during management of present and future projects. For example, if an oil trade project is affected by an increase in world oil prices, users traditionally focus on resolving problems associated with that oil trade project. Users also locate and resolve problems associated with other projects that are directly affected by the oil price increase. In prior art risk management systems, projects that are indirectly affected by factors that mitigate the success of one project, for example the oil price increase, remain undetected. In accordance with the principles of the present invention, by using the search tool, even when projects are not related to oil, as long as the word “oil” is in any part of the project, such as in the forecasting module, the user will be able to find projects affected by the increase in world oil prices. In this manner, a company can analyze projects that are both directly and indirectly associated with oil.

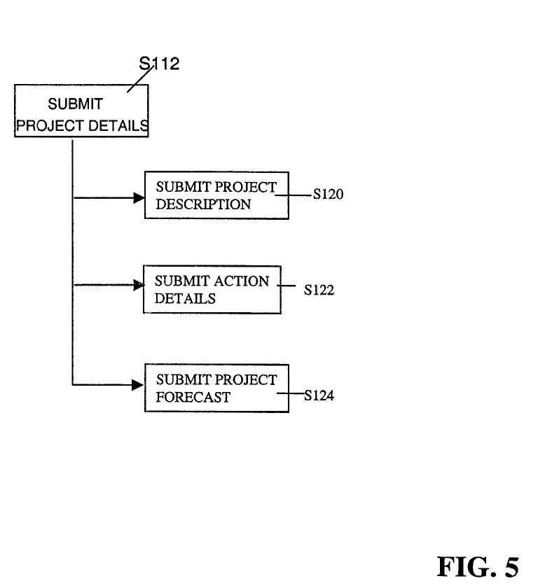

FIG. 5 shows a flow chart describing in greater detail the components comprising step S112 (submit new product details). In step S120, a new project, for example an investment or loan and/or deferred payment, is identified in a completed proposal form and submitted by a department to an investment committee. Therein, project descriptions, time schedules, action plans, and forecasts are further submitted (steps S122 and S124, respectively). For example, action plan details include time frames estimated for actions, descriptive details of actions, and action members responsible for completing the actions. Moreover, any mitigating factors, for example, labor shortages, natural catastrophes and the like, are identified and provided therein. After receiving the project description, action plan details, and forecasts, the investment committee makes an informed decision whether or not to invest resources (e.g., capital, time, and personnel) in the project. After the project has been approved and the project and its associated actions plans are added to the automated risk management system 10, a series of dates are assigned for each action plan.

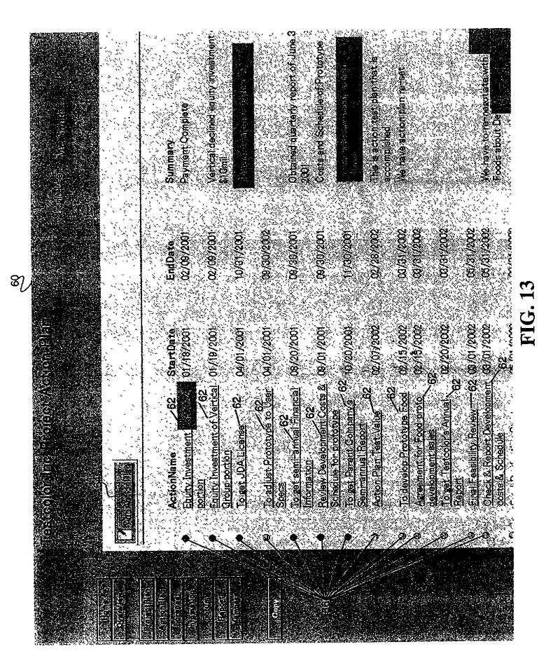

When action members assigned to the action plans associated with a project complete their respective action plans, details of the completed action plans are preferably added to the automated risk management system 10. The action member preferably invokes a process whereby the automated risk management system 10 notifies, preferably by e-mail, project members associated with the action plan, and any authorized personnel, for example an investment committee representative. In a preferred embodiment the investment committee representative evaluates the information, and after investigation and discussion with the project member(s), assigns a value represented by a colored icon 66 to the action plan, substantially as shown in FIG. 13. For example, an action plan associated with a project that has an exemplary status is assigned a green colored icon, for example, a filled-in circle. An action plan that has a conditional status, where the likelihood of it being reassessed at a later time as exemplary is high, is assigned a yellow colored circle. An action plan that has serious issues or that is delinquent is assigned, for example, a red colored circle.

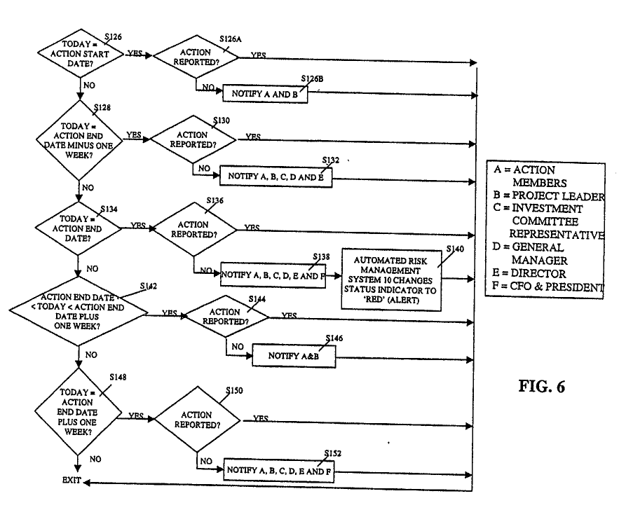

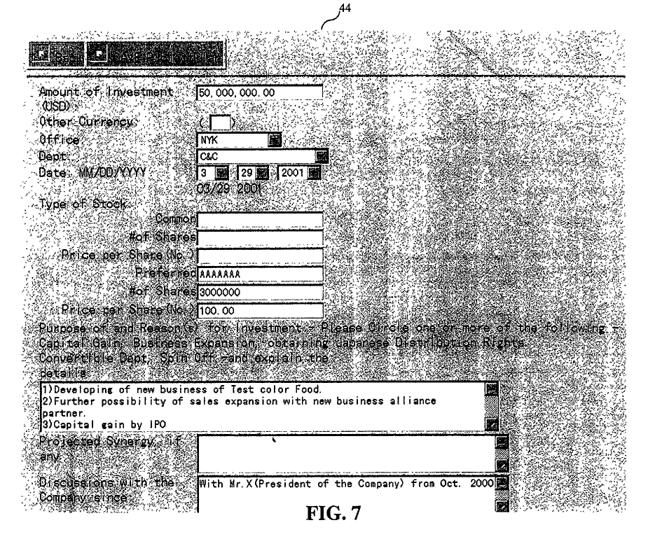

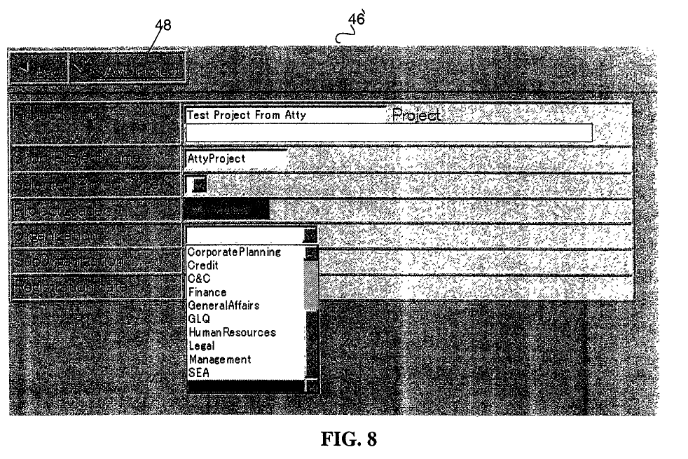

FIG. 6 shows a flow chart that represents details of the development and implementation for a single project (step S116, FIG. 4B). The automated risk management system 10 preferably performs an evaluation for all action plans and all projects in the system everyday, and, according to pre-defined rules, automatically notifies specific parties of the statuses of actions plans and projects. Details of the rules employed for notifying parties in a preferred embodiment of the present invention are discussed in detail below. Preferably, the automated risk management system 10 automatically notifies parties by e-mail. Of course, one skilled in the art will recognized that any manner of notification is contemplated herein. By notifying parties of dates and scheduled activities associated with projects, the likelihood of actions associated with specific projects not being performed is significantly reduced. Also, the likelihood of any one person having to resolve a problem on his/her own is avoided. Errors will be uncovered and resolved quickly before he/she tries to hide them, hoping that the situation will improve. Problems will thus get the proper attention before they get out of control.

In step S126 (FIG. 6), the automated risk management system 10 determines whether the start date for the action plan has been reached. If the current date equals the start date for the action plan, then the automated risk management system 10 determines whether performance of the action plan has been reported by the respective action member(s) (step S126A). If no action has been reported, the automated risk management system 10 preferably notifies action members and the project leader that the beginning date has arrived (step S126B). As noted above, action members may include individuals outside of the project member's organization that are also involved with the investment project, i.e., partners.

In step S128, the automated risk management system 10 determines whether the current date is a week before a specific action end date. If so, the system determines whether performance of an associated action plan has been reported by the respective action member(s) (step S130). If no action has been reported, the automated risk management system 10 preferably increases the parties who are notified of the delinquency, including action members, the project leader, investment committee representatives, the general manager and directors that no action has been reported (step S132).

When a scheduled end date for an action plan arrives (step S134), then, as shown in step S136, the automated risk management system 10 determines whether any action has been reported. If no action has been reported, then, in step S138, the automated risk management system 10 preferably notifies a larger number parties than, for example, as were notified in step S132, and notifies, for example, action members, the project leader, investment committee members, the general manager, director, the chief financial officer, and the president of the action delinquency. Also, the automated risk management system 10 changes the action status indicator to red, representing an alert (step S140). By increasing the number of parties that are notified, and by adding parties with greater authority, for example directors, the chief financial officer and the president within a corporation as the severity of a delinquency increases, the likelihood that parties respond and complete action plans increases. In addition, by preventing any one person from attempting to resolve a problem on his/her own, decision-makers can address problems at an early stage.

After the automated risk management system 10 determines that the ending date for an action plan has passed, the system 10 determines whether the present date is within a week of the scheduled action plan end date (step S142). If so, another determination is made whether any action has been reported in the system (step S144). If no action has been reported at that time, the automated risk management system 10 preferably again notifies action members and the project leader of the delinquency (step S146).

In step S148, the automated risk management system 10 determines whether the current date is seven days after the scheduled action plan end date. If so, the automated risk management system 10 determines whether any action has been reported (step S150). If no action has been reported at that time, the automated risk management system 10 preferably notifies the same parties as were notified in step S138, including, for example, action members, the project leader, investment committee representatives, and upper level management (e.g., the general manager, the chief financial officer and the president) of the delinquency (step S152), causing the investment committee to convene in order to discuss the delinquency.

Any time an action plan is reported, the automated risk management system 10 preferably notifies the investment committee representative(s) regarding the status of the action plan. After the investment committee has been notified of the reported action plan, the reported submission is preferably assessed and valued. If an action plan has previously been assessed with an unfavorable value, the investment committee representative(s) will reevaluate the action plan activity.

Therefore, as illustrated by the foregoing flow charts, action plans associated with projects are assessed. If action members are delinquent in submitting information to the automated risk management system 10, a plurality of project members, directors and upper management are notified of the delinquency. At any time during the life cycle of a project, actions associated therewith are valued. In accordance with the principles of the present invention, each project inherits a status value associated with the one associated action plan having the least favorable assessment. For example, a project having one delinquent action plan and ten non-delinquent action plans will inherit the status of the delinquent action plan and will be assessed as delinquent. In this example, the status indicator for the overall project is a red status indicator because the most delinquent action plan associated with the investment has a red status indicator. A user uses the automated risk management system 10 to identify action plans that have been assessed with some form of delinquency. The project leader and/or action members identifies the delinquent action plan(s) associated with the project, and, thereafter, remedies the one or more delinquent action plans.

As described above with reference to FIG. 5 (step S112), a department that desires to implement a new project submits proposal documentation to an investment committee for approval. FIG. 7 shows an example new proposal display screen 44 that is used for adding a new proposal in the automated risk management system 10. In the example shown in FIG. 7, a $50 million investment is proposed for the purchase of a corporation, Test Color, Incorporated. As shown in FIG. 7, a user provides a significant amount of detail regarding the investment including reasons for the investment, the value of the investment, details of communications, future investments and demographic information. If, as in the example shown in FIG. 7, the project is an acquisition of a corporation, the user submits information directed to the corporation's business practices, product descriptions, principals in the corporation, profit and loss statements, liabilities, investors, stock information, and associated risk analysis including market competition, credit, inventory, industry and the like (not shown). Moreover, the user preferably submits information describing the market size, market share and competition of the investment corporation. The user also preferably submits a valuation analysis of the investment and includes a consultant's report valuing the corporation in relation to its respective industry. In a preferred embodiment, a plurality of electronic data can be submitted as attachments in the proposal data entry screen 44. Data that are entered during the proposal stage of a project are preferably saved during the time that a decision regarding the project is being made by an investment committee. The data are preferably available for archival purposes in the event the proposal is rejected, or integrated into the modules of the automated risk management system 10 if the proposal is accepted.

In addition to acquisitions, risk management system 10 preferably accommodates other kinds of projects, for example, loan and/or deferred payment proposals and real estate investments. Proposals are entered into risk management system 10 substantially as shown in FIG. 7, and an investment committee preferably reviews the information prior to deciding whether to proceed with the proposal.

Thereafter, additional data, for example, project members, action plans, and forecasts are added via the input/output modules of the automated risk management system 10. All added data are stored substantially in “real-time” in a reviewable knowledge base. This knowledge base assists with project follow-ups, helps to identify projects that will be affected by a significant event or occurrence, and is a source of knowledge to help ensure the success of future projects.

FIG. 8 shows a sample add a new project form 46 that is presented on a display screen when a user formally promotes an investment proposal to a new project in the automated risk management system 10. Using a series of graphic controls including, for example, text boxes, drop-down lists, hyperlinks, push buttons and the like, a user submits project-related information including, for example, a project name, a project leader, a source organization, and a registration date. When the user completes the added new project form, he or she preferably saves the data for future use, for example, by clicking the save project hyperlink 48.

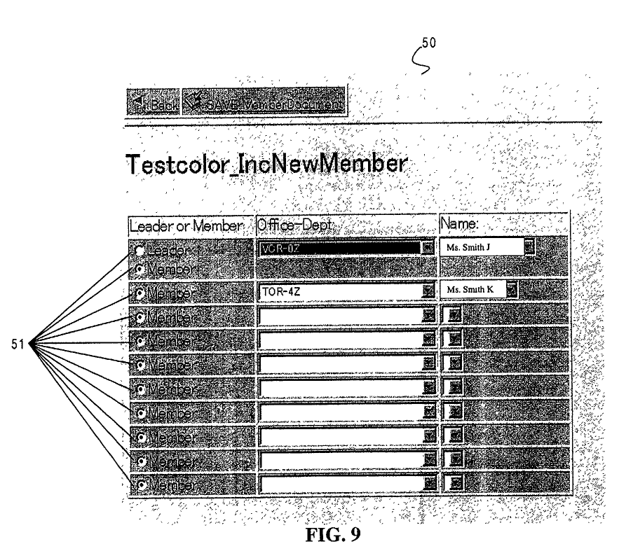

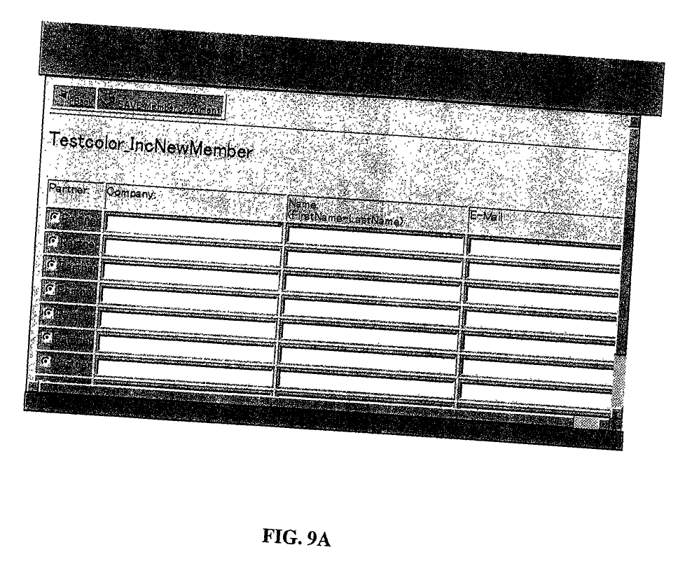

Once a new project is entered into the automated risk management system 10, the user preferably assigns project members who are associated with the new project. FIG. 9 shows an example of add a new project member display screen 50 for adding new project members in the automated risk management system 10. In the example shown in FIG. 9, a user adds a new project member and identifies, via leader or member control 51, a hierarchical status for the person. In the example shown in FIG. 9, project members are identified as either members or leaders. Project members can include persons outside the company. Such members are identified as partners and are entered in the automated risk management system, as shown in FIG. 9A. Of course, one skilled in the art will recognize that project members can be classified into other groups. By enabling classifications of project members, the automated risk management system 10 preferably performs operations on data grouped by classification.

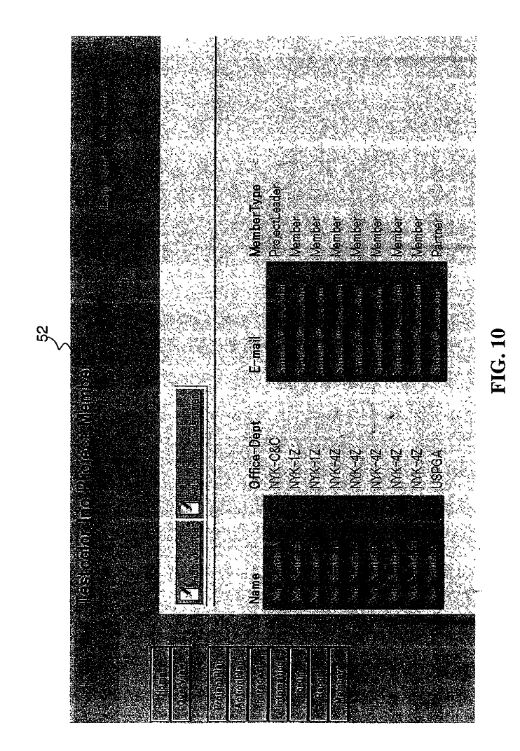

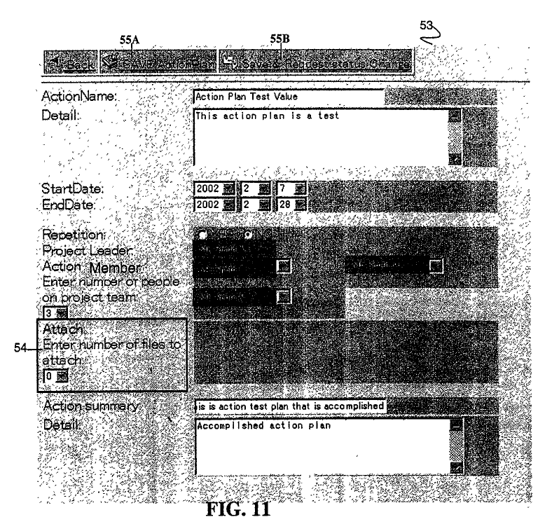

After project member data are added to the automated risk management system 10, a user preferably reviews the data in other display screens, for example, in the project member list display screen 52 (FIG. 10). In a preferred embodiment, users select a name in the project member list display screen 52 by clicking on an associated hyperlink. Selection of the hyperlink preferably instructs information processor 12 to display a data entry display screen such that users can review and edit data associated with the selected project member.

After a project has been successfully added to the automated risk management system 10, action plans associated with the project are entered into the system 10. FIG. 11 shows an example add a new action plan display screen 53 that is associated with a project in this case, the acquisition of Test Color, Incorporated. As shown in FIG. 11, a user submits action plan data via graphic controls for a plurality of elements, for example, action name, a textual description of the action plan, start and end dates for the action plan, whether the action plan is being repeated, associated project leaders, associated action members selected from project members registered in FIG. 10, and, when the action plan is complete, action plan summary information. Moreover, in a preferred embodiment, a user is afforded an opportunity to attach one or more external data files via attach data control 54. After completion, the user clicks on the save action plan hyperlink 55A, which saves data into the automated risk management system 10.

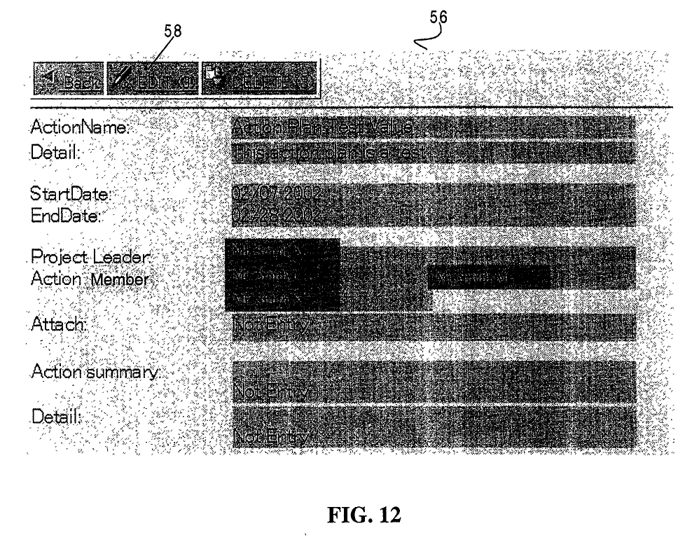

After action plans have been submitted in the automated risk management system 10, a user preferably reviews and edits the data associated therewith, for example, as shown in the review an action plan display screen 56 (FIG. 12). When a user wants to change or add any data therein, the user preferably edits the data by selecting the edit action hyperlink control 58. Once the edit action plan hyperlink control is selected, a display screen substantially similar to the add a new action plan display screen 53 is presented for the user to make adjustments or additions to the action plan data.

FIG. 13 shows an example action plan list display screen 60 that lists and identifies action plans associated with a specific project. In the example action plan list display screen 60, a plurality of action plans are shown including scheduled equity investments, plans to receive reports and other information, complete feasibility reviews, and obtain necessary licenses. In a preferred embodiment, each of the action plans listed is represented as action plan hyperlink controls 62. When a user selects an action plan hyperlink control 62, details regarding the corresponding action plan are preferably presented in a review action plan display screen 56 (FIG. 12). In a preferred embodiment, action plan list display screen 60 includes an add action plan hyperlink control 64 to enable a user to add a new action plan to the associated project.

The action plan display screen 60 lists data elements directed to one or more action plans listed therein. In the example shown in FIG. 13, the action plan name, start and end dates, and a textual description of the action plan are displayed. In a preferred embodiment, an icon is also provided which represents an assessment of the action plan with respect to its status. Each action plan is assigned an icon, for example, a green, yellow, or red circle, or a circle with a small face. In the example shown in FIG. 13, the action plan, “Equity Investment of Vertical Group Portion,” has a green status indicator control 66. The action plan, “Action Plan Test Value” has a yellow status indicator control 66. The action plan, “To get Parent Company's Semi-annual Report” has a red status indicator control 66. The action plan, “To Develop Prototype Food,” has a status indicator of a small face that indicates that the scheduled action plan has not reached the action plan end date and no action has been taken, or action has been taken and assessment has not yet been made. As noted above, the action plan having the least favorable assessment, represented by a specific status indicator, will determine the status of the entire project.

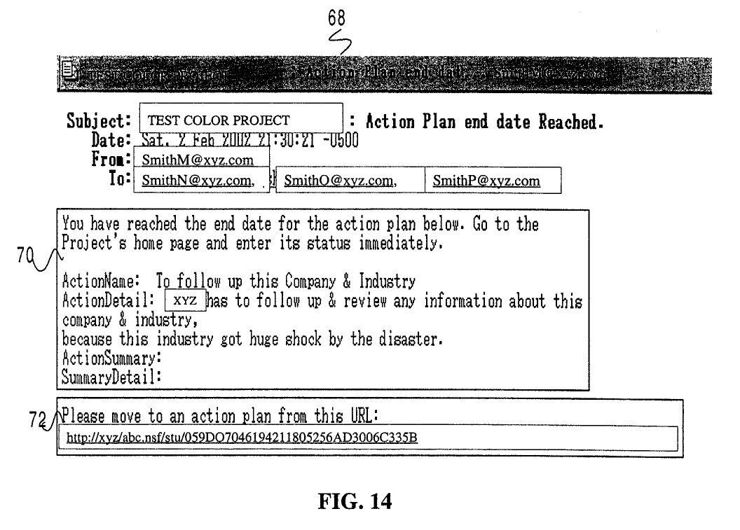

FIG. 14 shows an example action plan warning notification display screen 68 that is automatically transmitted when an action plan becomes delinquent. In the example shown in FIG. 14, an action plan warning description text box 70 identifies the nature of the delinquency, details regarding the action plan, and presents one or more directives for remedying the problem. Moreover, the action plan warning display screen 68 comprises an action plan hyperlink 72 that, when selected, causes host processor 12 to display review action plan display screen 56 (FIG. 12). Using the review action plan display screen 56, the user preferably selects the edit action plan hyperlink control 58, and provides summary information describing a resolution to the action plan delinquency. In the event that the action members do not remedy the delinquency, the automated risk management system 10 increases the seriousness of the e-mail message, such as the example shown in FIG. 14, and also increases the number of recipients thereof.

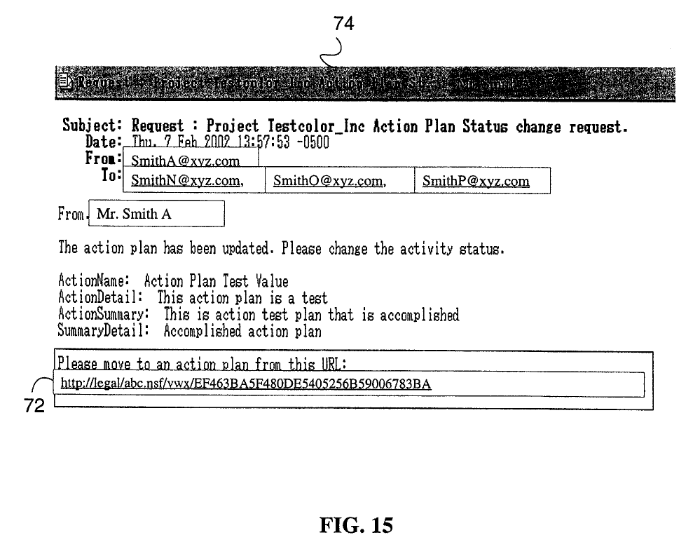

After a user navigates the display screens in the automated risk management system 10 and updates the database herein by submitting action plan-related information, the automated risk management system 10 preferably notifies one or more parties, preferably the project members and the investment committee representative, and further requests an activity status update. The request is sent preferably by e-mail when the user clicks on the save and status change action plan hyperlink 55-B (FIG. 11). FIG. 15 shows an example action plan status update request screen 74 that is preferably automatically transmitted after an action plan has been updated and status change has been requested. Similar to the action plan status warning display screen 68 (FIG. 14), an action plan hyperlink 72 control is preferably available for an investment committee representative to assess the updated action plan information. In the example shown in FIG. 15, the notification is an e-mail message. Of course, one skilled in the art will recognize that any form of notification is contemplated herein.

After investment committee representative is notified, the action plan is preferably rated. FIG. 19 shows an example action plan update display screen 104 that is accessed to submit information in the automated risk management system 10 directed to the status of an action plan. FIG. 19 contains the action plan name, a textual description of the action plan, start and end dates for the action plan, project leaders and action members, electronic file attachments, action summary and textual details thereof. Active option list control 106, preferably available only to the investment committee representative, provides the investment committee representative the functionality of assigning a status indicator to the action plan. The control 106 provides a list of choices, of which only one can preferably be selected, and represents the status of the action plan following review of action plan update information submitted by action or project leader members. As shown in the action plan update display screen 104, the choices available in the active option list control 106 include choices for indicating that the action plan has started, the action plan was completed successfully, a warning status that some delinquency exists, and an alert status that indicates a critical delinquency. An active option list control 107, also preferably available only to the investment committee representative, includes a choice to indicate an end choice for terminating the project as scheduled, a write-off choice to represent the action plan and the project as written off the books, and a give-up choice for forgiveness of collection on the associated project. As noted above, the selection made in the active option list control 106 and 107 has a potential impact on the overall status of the associated project. Specifically, the one action plan having the least favorable assessment determines the overall status level for the project.

The automated risk management system 10 maintains a history of updates and changes that take place for each action plan (FIG. 19A). Only users authorized to have access to active option list controls 106 and 107 have access to this information. Preferably a history entry is automatically generated whenever the system automatically changes an action plan status to a red alert status or whenever any changes are made to any portion of the action plan, such as the action plan start and end date, summary, and detail. If the recorded change is that the action plan status was changed to red, authorized users will know what the cause of the change was, whether the automated risk management system 10 automatically changed it, or whether the investment committee representative changed it. Also, this function preferably prevents unauthorized changes to the action plan by users who try to hide information or who try to mislead other users.

Preferably, this history feature additionally aids in project analysis. For example, there may be a customer that requests a payment extension. Generally, the extension is granted, and the action plan end date is changed to a later date. Regarding customers that repeatedly request extensions, regardless of how far in the future the action plan end date is, and regardless of the fact that the action plan status is a small face, authorized users will preferably be able to discern from reviewing the history that the customer is a company that potentially has problems.

During the course of development of a project, project members depend upon electronic resources provided by the automated risk management system 10 to successfully complete their tasks. The automated risk management system 10 provides a plurality of electronic resources that enable project members to complete their respective tasks in a timely fashion. For example, information module 38 (FIG. 3) is accessed by project members to disseminate electronic documents, databases, and post uniform resource locators to relevant Internet web sites. This module also provides host system data for accounting information. Project members access the forum module 40 (FIG. 3) in order to share ideas, to post comments and suggestions, and also to pose questions. Forecast module 36 (FIG. 3) provides project members a listing of factors that may potentially affect the outcome of the project. Reports module 42 (FIG. 3) provides project members with information including a plurality of financial and annual reports, and a plurality of ad hoc reports. By using these electronic resources, project members can complete projects and action plans in a timely fashion.

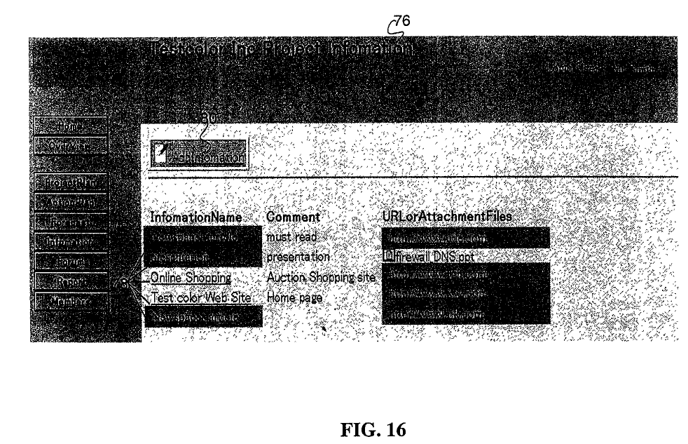

FIG. 16 shows an example information module display screen 76 that is used as a resource to review one or more external electronic information sources. In the example shown in FIG. 16, information source hyperlink control 78, when selected, causes an electronic resource associated with the hyperlink to be displayed on the user's terminal display 14 (FIG. 1). Continuing with the acquisition of Test Color, Incorporated example, FIG. 16 shows a hyperlink to a presentation file, a hyperlink to a shopping web site, a hyperlink to Test Color's home page, and a news source link for electronic resources for the project member. Hyperlinks to data from host systems are also envisioned. These resources preferably reside on a plurality of information processors 12, for example on public Internet web sites and on private intranet and extranet sites. When a project member has information, such as a valuable resource available via a hyperlink, to contribute to the information module 38 (FIG. 3), he or she preferably selects the add information hyperlink control 80 (FIG. 16) and submits a name for the resource, a short comment describing the resource, and a uniform resource locator, database, or electronic document attachment file therefor. Also, the automated risk management system 10 preferably automatically receives host system data which is automatically entered as information. As shown in FIG. 16, in addition to the “alias” name of the resource, a formatted uniform resource locator or attachment file is also displayed for the project member's review.

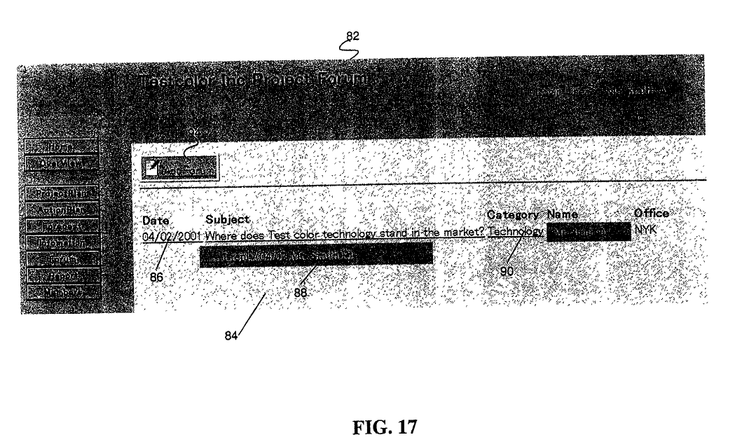

FIG. 17 shows an example project forum display screen 82. The project forums available via the automated risk management system 10 enable project members to pose questions and comments, and to retrieve information directed to the project. In the example project forum display screen 82 shown in FIG. 17, a project member has submitted a question in forum subject list 84 regarding the status of the technology for the product manufactured by Test Color, Incorporated. By selecting the date hyperlink control 86, the subject hyperlink control 88, or the category hyperlink control 90, a project member can review the selected subject and can reply to the selected subject. When a project member has a topic to contribute, for example, a question he or she wishes to pose, the add forum hyperlink control 94 is preferably selected, and the project member is presented with a data entry display screen for submitting forum subjects.

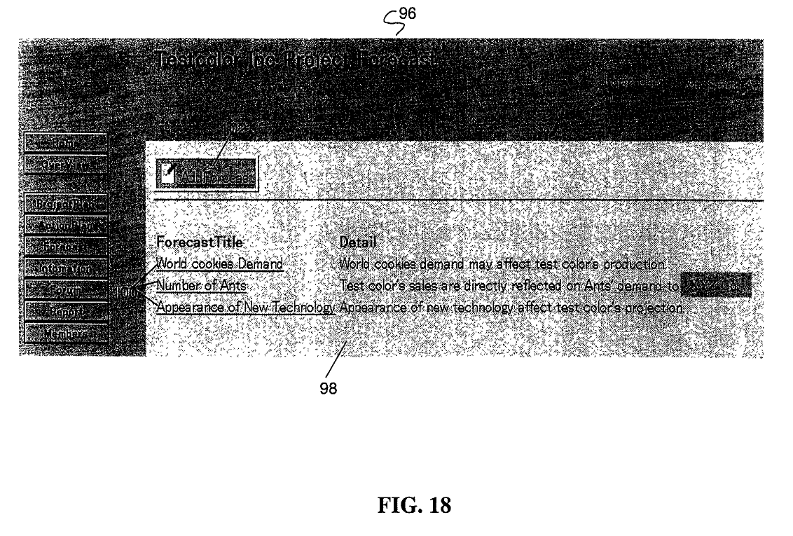

FIG. 18 shows an example project forecast display screen 96 that is preferably available to enable project members to review and/or add forecasts or other issues that potentially may mitigate the success of a project. Forecasts provide valuable information that may be pivotal during the decision-making process. In the example shown in FIG. 18, the project forecast list 98 identifies a number of forecasts that potentially affect Test Color, Incorporated's profitability. Included therein are a plurality of forecast hyperlink controls 100 that, when selected, preferably provide a project member with the name of the forecasts and textual descriptions thereof. Project members preferably select add forecast hyperlink control 102 to submit a new forecast directed to the project.

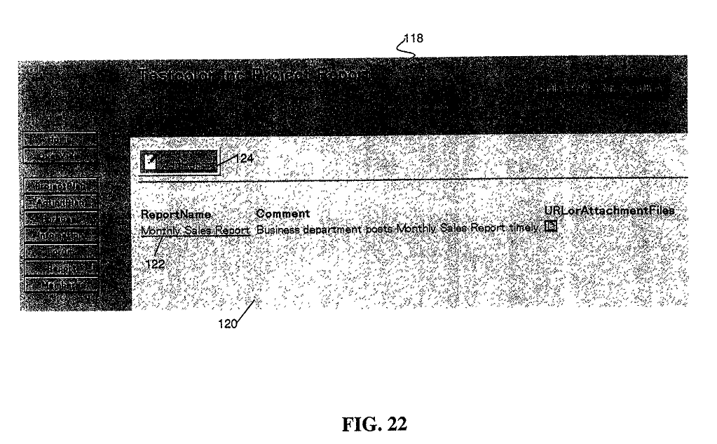

During and after a project's development, a plurality of information reports are preferably available via the automated risk management system 10. FIG. 22 shows an example reports display screen 118 that provides project members with access to output reports and other electronic information directed to projects. In the example shown in FIG. 22, the reports list 120 comprises a list of reports or other electronic files that are available. By selecting a report name hyperlink control 122, the project member is preferably presented with the associated report. Occasionally, a report is produced in a separate application and available for download via reports list 120. Alternatively, a report directed to a project is stored on a HTTP server, and an associated uniform resource locator is preferably available within report list 120 to direct the information processor 12 to display the report on the user's display 30 (FIG. 2). As shown in FIG. 22, project members who have one or more reports to add to the automated risk management system 10 preferably select the add reports hyperlink control 124. Once selected, this control causes information processor 12 to present a data entry display screen for adding a new report. Project members are afforded an opportunity to provide a uniform resource locator, database, or electronic document attachment file located on an information processor 12.

After the Test Color, Incorporated acquisition project is successfully completed, a template of related action plans and other associated data are preferably available to generate a new investment project that is based thereon. This feature of developing new projects quickly based upon previously successfully completed projects is a useful and time saving feature provided by the automated risk management system 10.

Of course, any other authorized users, such as investment committee members, the chief financial officer and the president, can also access these modules.

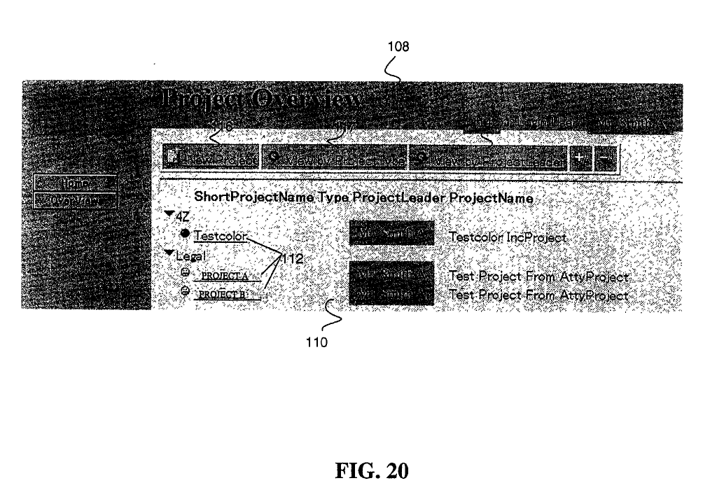

At any time during the development of an project, users of the automated risk management system 10 preferably access an project overview display screen 108, as shown in FIG. 20. Projects being managed by the automated risk management system 10 are preferably ordered by department, and have associated status indicators representing the status of the overall project. In the example shown in FIG. 20, the Test Color, Incorporated acquisition is identified by the proposing department, 4Z. Moreover, the status indicator for the Test Color, Incorporated project in the example shown in FIG. 20 is a green circle. In a preferred embodiment, a green status indicator indicates compliance with schedules and associated deadlines. Project hyperlink control 112, when selected, preferably causes information processor 12 to display a data entry display screen for reviewing and editing information directed to the selected project. Moreover, the user is able to navigate to specific action plans associated with the selected project by selecting one or more graphic controls, for example, action plan-related hyperlinks.

In a preferred embodiment, the view by project-type hyperlink control 117 (FIG. 20), when selected, causes a list of projects to be ordered by project-type. Alternatively, the view by project leader hyperlink control 114 sorts the projects by project leaders. When a user has a new project to add to the automated risk management system 10, he or she preferably selects the new project hyperlink control 116, which causes the information processor 12 to display the add a new project display screen 46 (FIG. 8).

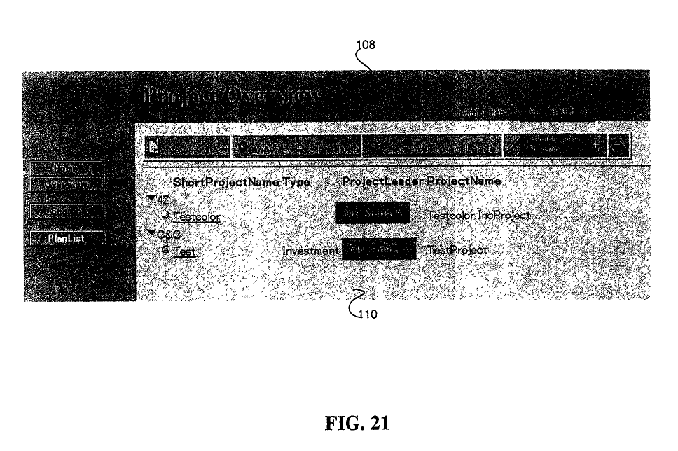

FIG. 21 shows another example project overview display screen 108. Unlike the project overview display screen 108 shown in FIG. 20, however, the Test Color, Incorporated project status indicator has changed from green to red.

In a preferred embodiment, a red status indicator indicates a critical delinquency. A project member viewing the project overview display screen 108 shown in FIG. 21 recognizes that a delinquency exists that is associated with the Test Color, Incorporated acquisition, and selects the hyperlink control 112 associated with the Test Color, Incorporated project. After the project member selects the project hyperlink associated with the Test Color, Incorporated acquisition project, he or she is preferably presented with the action plan list display screen 60 (FIG. 13), and identifies the specific action plan having the delinquent status action indicator associated therewith. Using the action plan hyperlink control 62 available in the action plan list display screen 60, the project member navigates to the specific action plan having the delinquency, and hopefully remedies the cause for the delinquency.

In this way, project information is made instantly available to a plurality of parties associated with projects; and causes for delinquencies, including, for example, delays, exigencies, forecasts, and the like can be easily identified and remedied. The automated risk management system 10 enables companies incurring risk to closely monitor and resolve issues related to various investment projects.

The integration of modules, display screens, graphic controls, and functionality described herein provides a unique, efficient, and valuable resource for project and risk management. The automated risk management system 10 provides access to project and action plan details to a potentially limitless number of people, and, further, enables various levels of access to select parties by restricting access to specific areas therein. Moreover, the automatic notification of delinquencies of projects and action plans reduces the possibility of actions plans and projects from becoming further delinquent to the point of being unremediable.

Additional functionality provided by the automated risk management system 10 is now further described by way of an example.

A department, Loan Management, in a large corporation identifies an investment opportunity. The investment is a loan and deferred payment opportunity having an estimated profit of approximately $6.5 million. The Loan Management department desires to implement the investment via the automated risk management system 10. The Loan Management department completes a loan and/or deferred payment proposal form that includes information directed to the investment, borrower information, reasons for the loan, disbursement information, funding source information, security collateral information and financial reporting. Moreover, the department submits various risks caused by mitigating factors for specific countries, markets, credit history, inventory status, industry, funding, operations and the like.

After the proposal form is submitted and information is entered in the automated risk management system 10, an investment committee convenes and weighs the option of pursuing the investment. Following careful deliberation, the investment committee elects to pursue the investment.

The investment being proposed by the Loan Management department becomes a formal project, and is entered in the automated risk management system 10 in the add a new project display screen 46 (FIG. 8). After details of the project, including the project name, the type of project, and registration dates are submitted, the user entering the project in the automated risk management system 10 preferably selects save project hyperlink control 48. Once the save project hyperlink control 48 is selected, the automated risk management system 10 preferably allocates storage space on information processor 12 for the new project.

After the project is entered in the automated risk management system 10, the project leader preferably navigates to add a new project member display screen 50 (FIG. 9) and provides the leader and members associated with the project. Thereafter, any partners are entered.

After project members have been added to the automated risk management system 10, action plans associated with the project are preferably added to the system, for example, by navigating to add a new action plan display screen 53 (FIG. 11). Action plans that are added therein are closely monitored as time passes, and selected parties are notified of the progress of the respective action plans.

When an action plan to be implemented, for example, a feasibility review, is completed, the action member prompts the automated risk management system 10 to report that the action has been completed. The system 10 requests an action plan status update from the investment committee representative(s). The investment committee representative determines from the feasibility review that the project has sufficient collateral and funding, and assigns a favorable action plan indicator to the action plan.

Over time, however, another action plan (reception of a quarterly report) is not being completed in a timely fashion. On the action plan's start date, the automated risk management system 10 preferably notifies action members and the project leader that the action plan start date has arrived. Within a week of the scheduled action plan end date, the automated risk management system 10 increases the severity of the delinquency by notifying an investment committee representative, the general manager, and director. Immediately, the parties collectively resolve the problem by identifying the parties responsible for delivering the quarterly report and pressuring them to deliver. By the time the date is equal to the scheduled action plan end date plus one week, the automated risk management system 10 notifies action members, partners, investment committee representatives, the general manager, the director, the chief financial officer, and the president. This level of notification prompts the respective parties to make significant inquiries into the nature of the delinquency, and within a day, By increasing the frequency, severity and number of parties of the notification, the problem is resolved before causing irreparable harm and precluding this and other projects from successful completions.

When the project is complete, a template becomes available for future projects that bear substantial similarity to the loan and deferral payment project implemented by the Loan Management department. Moreover, other projects relying upon quarterly reports are managed more effectively as a result of the processes associated with the management of the loan and deferral payment project

Although the preferred embodiment described herein refers to capital investments and acquisitions, the invention is not so limited. For example, a manufacturing corporation decides to invest in substantial machinery to improve their manufacturing processes. The manufacturing corporation uses the automated risk management system 10 to implement the process of adding the new machinery to their manufacturing processes. For example, proposals are submitted to a committee that decides whether to invest in the new machinery. The department(s) that is directly involved in the acquisition of the machinery defines and submits a plurality of action plans in the automated risk management system 10 that are associated with the investment. And the relative success of the implementation project is effectively represented by the successful completion of all action plans associated with the investment, as displayed by the automatic risk management system 10.

In another example, a medical practice elects to invest in new machinery for surgical procedures. Again, the automated risk management system 10 is used to qualify and quantify the relative success of the new surgical machinery implementation project.

It is envisioned that any organization involved in capital outlay and/or investments that incur risk can benefit substantially by the functionality provided by the automated risk management system 10.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method to manage risk associated with an investment, said method comprising:
receiving project information, said project information including at least one of a description of said investment, a description of risk associated with said investment, a description of a project member, and a description of a project leader;
receiving action plan information, said action plan information representing an activity to implement said investment, said action plan information including at least one of a description of said activity, an action plan date range, and a name of at least one action member;
receiving action plan update information, said action plan update information representing progress of said activity;
assigning an action plan status indicator to said action plan information, said action plan status indicator representing said action plan update information; and
assigning a project status indicator to said project information, said project status indicator determined by analyzing said action plan status indicator.

2. The method of claim 1, further comprising:
receiving a plurality of said action plan information for a plurality of said activities;
assigning a respective action plan status indicator to each of said plurality of said action plan information; and
assigning said project status indicator to said project information, said project status indicator determined by analyzing at least one of said plurality of action plan status indicators.

3. The method of claim 2, wherein said step of analyzing comprises identifying a least favorable action plan status indicator among all action plan status indicators assigned to said plurality of action plan information.

4. The method of claim 2, further comprising generating a list of said project information.

5. The method of claim 4, wherein said list further includes a respective project status indicator for said project information.

6. The method of claim 4, further comprising reviewing said list to analyze said investment.

7. The method of claim 1, further comprising storing at least one of said project information, said action plan information, said action plan update information, said action plan status indicator, and said project status indicator in a database.

8. The method of claim 7, further comprising generating a new project from said stored project information and said stored action plan information.

9. The method of claim 7, further comprising retrieving at least one of said stored project information, said stored action plan information, and said stored action plan update information in said database to determine risk exposure, assist in decision making, and assist in project planning.

10. The method of claim 9, wherein said step of retrieving comprises receiving search criteria, said search criteria representing at least one of said project information, said action plan information and said action plan update information, and using said search criteria to locate at least one of said stored project information, said stored action information, and said stored action plan update information associated with said search criteria.

11. The method of claim 1, further comprising generating a history of changes to at least one of said action plan information and said action plan update information, said step of generating including:
receiving at least one action plan information modification, said at least one action plan information modification representing at least one change to said action plan information;
receiving at least one action plan update information modification, said at least one action plan update information modification representing at least one change to said action plan update information; and
storing at least one of said at least one action plan information modification and said at least one action plan update information modification in a database.

12. The method of claim 11, further comprising reviewing said history of changes to prevent an unauthorized change to said action plan information

13. The method of claim 11, further comprising reviewing said history of changes to analyze said investment.

14. The method of claim 1, further comprising modifying said action plan status indicator as a function of performance of said activity.

15. The method of claim 1, further comprising receiving project forecast information, said project forecast information representing factors that mitigate an outcome of said investment.

16. The method of claim 1, further comprising receiving action member responsibility information, said action member responsibility information representing at least one responsibility of said at least one action member.

17. The method of claim 1, further comprising notifying said at least one action member when said activity is pending.

18. The method of claim 1, further comprising outputting at least one of said project information and said action plan information to at least one of a display screen and a printing device.

19. The method of claim 1, wherein said investment includes at least one of a capital investment, a real estate investment, a deferred loan, inventory, machinery, and supplies.

20. The method of claim 1, further comprising categorizing a plurality of said project members into at least one group, and providing at least one of said project information, said action plan information, and said action plan update information to said at least one group of said plurality of said project members.

21. The method of claim 1, further comprising managing said risk over a communication network.

22. The method of claim 21, wherein said communication network is at least one of the Internet, an intranet, an extranet, a wide area network and a local area network.

23. The method of claim 1, further comprising transmitting at least one of said project information, said action plan information and said action plan update information to one person while transmitting at least one of said project information, said action plan information and said action plan update information to one other person to enable each of said one person and said one other person to do at least one of: monitoring said project information, determining whether resources to implement said investment are effective, deciding future investment strategies and determining profitability of said investment.

24. A method to manage risk associated with a project, said method comprising:
receiving project information, said project information including a description of said project and a description of risk associated with said project;
receiving action plan information, said action plan information representing at least one project activity to implement said project, said action plan information including at least one of a description of said at least one project activity, an action plan date range, and a name of at least one action member;
receiving action plan update information, said action plan update information representing progress of said at least one project activity;
assigning at least one action plan status indicator to said action plan information, said at least one action plan status indicator assigned as a function of said action plan update information;
assigning a project status indicator to said project, said project status indicator determined by analyzing said at least one action plan status indicator;
assigning a schedule for said at least one project activity, said schedule representing at least one date and at least one action member associated with said at least one project activity;
sending a notification to at least one person associated with said project when at least one of said at least one project activity is not performed in accordance with said schedule.

25. The method of claim 24, further comprising modifying at least one of the number of people receiving said notification and the recipients of said notification over a predetermined time period.

26. The method of claim 24, further comprising managing a plurality of said risks for a plurality of said projects.

27. The method of claim 24, further comprising generating a list of said project information.

28. The method of claim 27, wherein said list further includes a respective project status indicator for said project information.

29. The method of claim 27, further comprising reviewing said list to analyze said project.

30. The method of claim 24, further comprising modifying said notification over a predetermined time period.

31. The method of claim 24, further comprising generating a history of changes to at least one of said action plan information and said action plan update information, said step of generating including:
receiving at least one action plan information modification, said at least one action plan information modification representing at least one change to said action plan information;
receiving at least one action plan update information modification, said at least one action plan update information modification representing at least one change to said action plan update information; and
storing at least one of said at least one action plan information modification and said at least one action plan update information modification in a database.

32. The method of claim 31, further comprising reviewing said history of changes to prevent an unauthorized change to said action plan information.

33. The method of claim 31, further comprising reviewing said history of changes to analyze said project.

34. The method of claim 24, further comprising transmitting at least one of said project information, said action plan information and said action plan update information to one person while transmitting at least one of said project information, said action plan information and said action plan update information to one other person to enable each of said one person and said one other person to do at least one of: monitoring said project information, determining whether resources to implement said project are effective, deciding future project strategies and determining profitability of said project.

35. A system to manage risk associated with an investment, said system comprising:
a first software facility receiving project information, said project information including a description of said investment and a description of risk associated with said investment;
a second software facility receiving action plan information, said action plan information representing at least one activity to implement said investment, said action plan information including at least one of a description of said at least one activity, an action plan date range, and a name of at least one action member;
a third software facility receiving action plan update information, said action plan update information representing progress of said at least one activity;
a fourth software facility assigning an action plan status indicator to said action plan information, said action plan status indicator assigned as a function of said progress of said at least one activity; and
a fifth software facility assigning a project status indicator to said project information, said project status indicator determined by analyzing said at least one action plan status indicator.

36. The system of claim 35, wherein said fifth software facility further generates a respective project status indicator for each of a plurality of said project information.

37. The system of claim 35, further comprising a sixth software facility generating a history of changes to at least one of said action plan information and said action plan update information, said step of generating including:
receiving at least one action plan information modification, said at least one action plan information modification representing at least one change to said action plan information;
receiving at least one action plan update information modification, said at least one action plan update information modification representing at least one change to said action plan update information; and
storing at least one of said at least one action plan information modification and said at least one action plan update information modification in a database.

38. The system of claim 35, further comprising a seventh software facility outputting at least one of said project information and said action plan information to at least one of a display screen and a printing device.

39. The system of claim 35, wherein said second software facility further receives said action plan information for a plurality of said activities, said fourth software facility further assigns a respective action plan status indicator for each of said plurality of said activities, and said fifth software facility further assigns said project status indicator to said project information, said project status indicator determined by analyzing at least one of said plurality of said action plan status indicators.

40. The system of claim 39, wherein said project status indicator is a least favorable action plan status indicator of said plurality of action plan status indicators.

41. The system of claim 35, wherein said second software facility further modifies said action plan information as a function of performance of said at least one activity.

42. The system of claim 35, further comprising an eighth software facility receiving project forecast information, said project forecast information representing factors that mitigate an outcome of said investment.

43. The system of claim 35, wherein said second software facility further receives action member responsibility information, said action member responsibility information representing at least one responsibility of said at least one action member.

44. The system of claim 35, further comprising a ninth software facility notifying said at least one action member when said at least one activity is pending.

45. The system of claim 35, further comprising a tenth software facility generating a list of said project information.

46. The system of claim 45, wherein said list further includes a respective project status indicator for said project information.

47. The system of claim 35, wherein said investment includes at least one of a capital investment, a real estate investment, a deferred payment investment, inventory, machinery and supplies.

48. The system of claim 35, further comprising an eleventh software facility transmitting at least one of said project information, said action plan information and said action plan update information to one person while transmitting at least one of said project information, said action plan information and said action plan update information to one other person.

49. A system to manage risk associated with a project, said system comprising:
a first software facility receiving project information, said project information including a description of said project and a description of risk associated with said project;
a second software facility receiving action plan information, said action plan information representing at least one activity to implement said project, said action plan information including at least one of a description of said at least one activity, an action plan date range, and a name of at least one action member;
a third software facility receiving action plan update information, said action plan update information representing progress of said at least one activity;
a fourth software facility assigning an action plan status indicator to said action plan information, said action plan status indicator assigned as a function of said progress of said at least one activity;
a fifth software facility assigning a project status indicator to said project, said project status indicator determined by analyzing said at least one action plan status indicator;
a sixth software facility assigning a schedule, said schedule representing at least one date and at least one action member associated with said at least one activity; and
a seventh software facility sending a notification to at least one person associated with said project when said at least one activity is not performed in accordance with said schedule.

50. The system of claim 49, wherein said fifth software facility further generates a respective project status indicator for each of a plurality of said project information.

51. The system of claim 49, wherein said seventh software facility further modifies at least one of the number of people receiving said notification and the recipients of said notification over a predetermined time period.

52. The system of claim 49, wherein said seventh software facility further modifies said notification over a predetermined time period.

53. The system of claim 49, further comprising an eighth software facility generating a history of changes to at least one of said action plan information and said action plan update information, said step of generating including:
receiving at least one action plan information modification, said at least one action plan information modification representing at least one change to said action plan information;
receiving at least one action plan update information modification, said at least one action plan update information modification representing at least one change to said action plan update information; and
storing at least one of said at least one action plan information modification and said at least one action plan update information modification in a database.

54. The system of claim 49, further comprising a ninth software facility generating a list of said project information.

55. The system of claim 54, wherein said list further includes a respective project status indicator for said project information.

56. The system of claim 49, further comprising a tenth software facility transmitting at least one of said project information, said action plan information and said action plan update information to one person while transmitting at least one of said project information, said action plan information and said action plan update information to one other person.
